(19) United States
(12) Patent Application Publication
(10) Pub. No.: US 2025/0204569 A1
(43) Pub. Date: Jun. 26, 2025

(54) GLYCINE-BASED NUTRITIONAL FOOD PRODUCT AND BEVERAGE COMPOSITIONS AND METHODS OF ADMINISTERING AND MANUFACTURING SAME

(71) Applicant: Eugene Peter O'Connor, Huntington Station, NY (US)

(72) Inventor: Eugene Peter O'Connor, Huntington Station, NY (US)

(21) Appl. No.: 18/848,112

(22) PCT Filed: Mar. 17, 2023
(86) PCT No.: PCT/US2023/015499

§ 371 Date: Sep. 17, 2024

Related U.S. Application Data
(60) Provisional application No. 63/320,728, filed on Mar. 17, 2022.

(51) Int. Cl. A23L 33/175; A23L 33/10; A23L 33/105; A23L 33/15; A23L 33/16

(52) U.S. Cl. CPC A23L 33/175; A23L 33/10; A23L 33/105; A23L 33/15; A23L 33/16

(57) ABSTRACT

Nutritional supplement compositions, methods of administering nutritional supplementation, and methods of manufacturing nutritional supplement compositions are described for improving sleep and energy availability in humans and other animals. The supplements include glycine or any substances that can be converted to glycine, or a combination of glycine or any substances that can be converted to glycine with vitamins, electrolytes, enzymes, food acids, amino acids, and/or trace elements. The methods of supplementation include administering to a user an effective amount of a composition including glycine or any substances that can be converted to glycine with vitamins, electrolytes, enzymes, food acids, amino acids, and/or trace elements.

### CROSS-REFERENCE TO RELATED APPLICATIONS

The present application claims priority to and the benefit of U.S. Provisional Patent Application No. 63/320,728, filed Mar. 17, 2022, the contents of which are hereby incorporated in their entirety.

### FIELD OF THE INVENTION

The present invention relates to promoting and/or enhancing sleep and energy availability in humans and other animals by consumption of glycine-based food products and beverages, and further relates to methods of preparing and administering the glycine-based food products and beverages. The inventive compositions in the form of a tablet, capsule, liquid or additive may comprise glycine or any substances that can be converted to glycine, or a combination of glycine with any substances that can be converted to glycine. The inventive compositions assist a user in falling asleep and/or reducing fatigue when waking up from sleep or providing an energy boost.

### BACKGROUND OF THE INVENTION

The prevalence of sleep disorders in the United States was the impetus for the Centers for Disease Control (CDC) to declare insufficient sleep a public health problem. Approximately 70 million Americans have chronic sleep problems (CDC, 2018). One in three adults do not get enough sleep on a regular basis (CDC, 2016). Insufficient sleep is experienced by approximately 30% of the general population over the age of 18 (CDC, 2018). A 2018 Consumer Report survey of approximately 1,800 people reported that one-third of these individuals used a prescription or over the counter (OTC) sleep aid and only one-third of those taking them reported very good or excellent sleep. Forty percent of those taking OTC sleep aids and 32% of those taking a prescription sleep medication reported feeling foggy or drowsy after waking.

### SUMMARY OF THE INVENTION

The present invention overcomes the shortcomings of the known sleep or energy-enhancing supplements. In an embodiment, the invention comprises a glycine-based composition that has multiple uses, i.e., the glycine-based composition, whether provided as a solid dosage form, included in a food product, or formulated as a beverage, enhances sleep and/or provides energy. In other words, consuming beverages or food products enhanced with the inventive composition induce sleep and deliver energy to assist a user fall asleep and/or reduced fatigue when waking up from sleep.

It will be appreciated by those skilled in the art that the inventive compositions are not limited to those based on glycine, but also may comprise substances which are converted to glycine, or combinations of glycine with the latter. The inventive compositions may further comprise one or more of: vitamins (including, but not limited, to B-vitamins), electrolytes, enzymes, food acids, amino acids, trace elements, proteins, fats, fatty acids, macronutrients, micronutrients, and/or phytochemicals. The inventive compositions may be realized in the form of tablets, capsules, or solutions/suspensions for oral administration, buccal or sublingual lozenges, additives for food or beverages, or other suitable forms as will be recognized by persons of ordinary skill in the art. Methods of using the inventive compositions to assist a user in more easily falling asleep and/or in waking from sleep feeling refreshed and energetic are disclosed. Further disclosed are methods of manufacturing the inventive compositions.

It will be appreciated by those skilled in the art that the foregoing brief description and the following detailed description are exemplary and explanatory of the invention, but are not intended to be restrictive thereof or limiting of the advantages which can be achieved by the invention. Thus, the accompanying drawings, referred to herein and constituting a part hereof, illustrate preferred embodiments of this invention, and, together with the detailed description, serve to explain the principles of the invention.

### BRIEF DESCRIPTION OF THE DRAWINGS

The features and advantages of the present invention, including as to its formulation, administration, manufacture and operation, will be apparent from the following detailed description, especially when taken in conjunction with the accompanying drawings, wherein:

FIG. 1 is an exemplary illustration of the KEY METRICS for falling asleep pre-usage and post-usage of an exemplary embodiment of the claimed invention in a product efficacy study;

FIG. 2 is an exemplary illustration of the KEY METRICS for waking up pre-usage and post-usage of an exemplary embodiment of the claimed invention in a product efficacy study;

FIG. 3 is an exemplary illustration of the LENGTH OF TIME TO FALL ASLEEP pre-usage and post-usage of an exemplary embodiment of the claimed invention in a product efficacy study;

FIG. 4 is an exemplary illustration of the FREQUENCY OF WAKING UP DURING THE NIGHT pre-usage and post-usage of an exemplary embodiment of the claimed invention in a product efficacy study;

FIG. 5 is an exemplary illustration of LENGTH OF TIME TO FALL BACK TO SLEEP pre-usage and post-usage of an exemplary embodiment of the claimed invention in a product efficacy study;

FIG. 6 is an exemplary illustration of a questionnaire regarding the intent to use an exemplary embodiment of the claimed invention in a product efficacy study;

FIG. 7 is an exemplary illustration of the LENGTH OF TIME TO WAKE UP FEELING REFRESHED AND ALERT pre-usage and post-usage of an exemplary embodiment of the claimed invention in a product efficacy study;

FIG. 8 is an exemplary illustration of a questionnaire regarding the need for a source of energy pre-usage and post-usage of an exemplary embodiment of the claimed invention in a product efficacy study; and

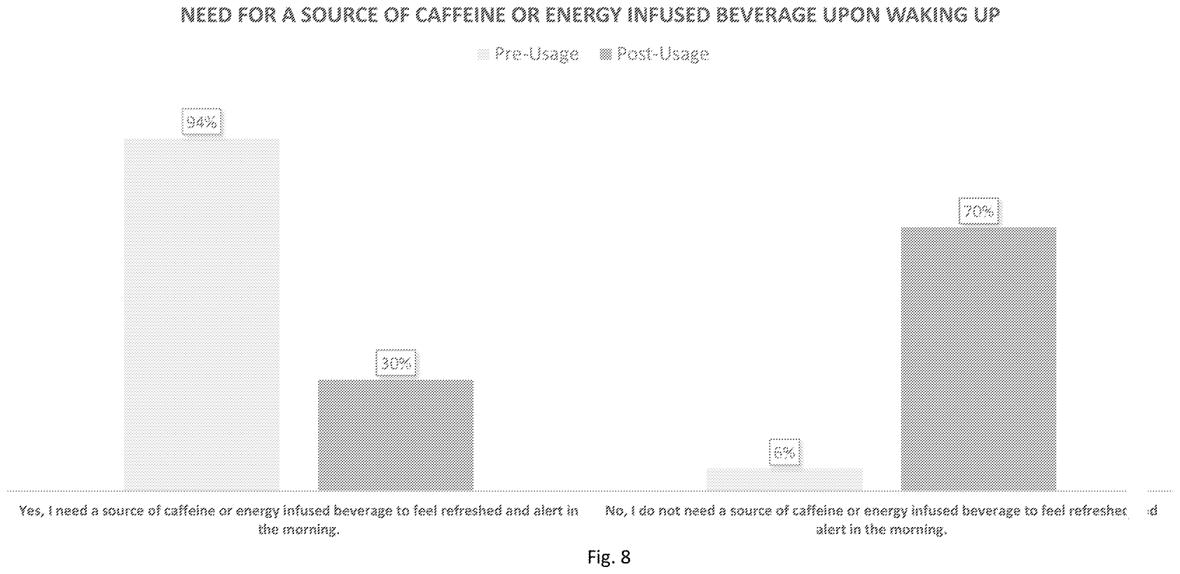

FIG. 9 is an exemplary illustration of a questionnaire regarding the intent to use an exemplary embodiment of the claimed invention in a product efficacy study.

### DETAILED DESCRIPTION OF THE INVENTION

The following is a detailed description of the exemplary embodiments of the invention, which are further described in the accompanying drawings. The exemplary embodiments are presented in such detail as to clearly communicate the invention and are designed to teach how to make and use the invention to a person of ordinary skill in the art. However, the amount of detail offered is not intended to limit the contemplated variations of the embodiments of the disclosed invention. On the contrary, the inventor intends to cover all modifications, equivalents, and alternatives falling within the spirit and scope of the disclosed invention, as defined by the appended claims.

The inventive compositions, after consumption, are absorbed during the digestive process and thereby effectively relieve insomnia and boost energy availability (making stored energy available for instant use). The inventive compositions function as boosters or health and wellness promotors, sleep supplements, fatigue relievers and/or preventers, supplements that aid in waking-up from sleep, supplements that aid in relieving and/or preventing fatigue when waking-up from sleep, or supplements that relieve/or prevent next day fatigue. The person of ordinary skill in the art will appreciate that the inventive compositions may be manufactured as tablets (including sublingual or buccal, orally disintegrating, and/or effervescent tablets or lozenges), capsules, liquids, and as food or beverage additives for consumption. The inventive compositions may further be formulated in controlled- or extended-release form; the person of ordinary skill in the art will appreciate that the controlled release formulation could be used to either prolong or delay the release of the inventive composition after administration. The inventive composition preferably contains glycine and/or any substances that can be converted or hydrolyzed to produce glycine but is not limited thereto.

In embodiments of the claimed invention, the glycine may be combined with one or more vitamins (including, but not limited, to B-vitamins), electrolytes, enzymes, food acids, amino acids, trace elements, proteins, fats, fatty acids, macronutrients, micronutrients, and phytochemicals, without limitation. The inventive compositions and method for manufacturing same may further include flavoring agents or other inactive ingredients. When glycine is combined with one or more of the above-listed substances, consumption produces in the user an inhibitory and/or excitatory effect on the mind and body. The inhibitory or excitatory effects do not overwhelm the user, but instead, in view of the novel composition, operate as an “on and/or off switch,” i.e., it may either sedate or energize the user. The inventive glycine-based compositions allow the user to choose whether they wish to sleep (whereinafter the inventive composition will act like a sedative) or wish to energize (whereinafter the inventive composition will act like an energizer). By working in concert on the body and mind, the inventive compositions render non-stimulating ingredients in the composition stimulating, and similarly render nonsedating ingredients sedating, as needed by the user.

There is no particular additional ingredient in the glycine-containing composition, the property of which provides the health benefits and affects described herein, but instead a synergy results from the presence and amounts of each and every one of the constituent elements.

In more detail, glycine is the simplest non-essential amino acid, denoted CH₂(NH₂)COOH. Glycine is an amino acid that is also recognized as a food additive and is contained in many foods. When combined with other substances, the glycine within the compositions and methods of administration produce a novel new use as a universal health improver. One of the functions of glycine when combined with the other ingredients disclosed herein is that it is able to both be an immediate and/or modified release to improve insomnia and/or energy aid which results in a universal health improvement overall. The compositions and methods of these substances disclosed herein work together on biological systems; for example, they work on the central nervous system but are not limited to just the central nervous system. When combined with other ingredients, the user is able to choose through their conscious and/or unconscious mind what effects of the composition they wish to utilize, sleep, energy or both sleep and energy. The effect of use of the composition will enable a user to initially feel tired. However, if the user resists the urge to sleep, the energy properties of the composition become active if they so choose. If a user chooses to sleep after ingesting the composition, they will have the delayed effect of energy that is apparent upon waking. The inventive compositions and the effects they create are a novel means to achieve both energy and/or improved sleep without the need for other stimulant and/or sedative products like caffeine or melatonin, and gives the user the choice through both conscious and/or unconscious mind, depending on their needs.

Foods and beverages that include the glycine-containing compositions, or that may be converted or hydrolyzed to render the glycine content readily available may be combined with any of vitamins (including, but not limited, to B-vitamins), electrolytes, enzymes, food acids, amino acids, trace elements, proteins, fats, fatty acids, macronutrients, micronutrients, phytochemicals, preservatives, flavoring agents and additives, without limitation. The resulting food or beverage products operate to induce sleep or make energy readily available and have a secondary effect of relieving the body and/or mind, curing and/or treating, enhancing, recovering and or replenishing the body and/or the mind to be energetic, boost energy levels and prevent fatigue, or if sleep is needed, to facilitate sleep.

The inventive compositions may be taken as a health beverage, dietary supplement or nutritional supplement, and may be taken with any other food, beverage, or dietary or nutritional supplement and may be taken in small quantities, such as in a mini-glass or shot in the case of a beverage.

### Example 1

The following is an exemplary embodiment presented for illustrative purposes only, which is not meant to be limiting.

The inventive composition may be manufactured in scale according to the following process and formula which describes quantities required for a single 60 ml serving. The ingredients a. thorough i., in the amounts listed below, are combined in distilled water in a beaker (e.g., a Griffin beaker):
a. 40 mg Himalayan Rock Minerals
b. 115 mg Potassium Chloride
c. 200 mg l-Malic Acid
d. 315 mg Choline l-Bitartrate
e. 4 mg Ferrous Sulfate Heptahydrate
f. 15 mg l-Tryptophan
g. 40 mg Pyridoxal-5-Phosphate (B6)
h. 8 g Glycine
i. 200 mg Magnesium Chloride Hexahydrate

Then, the mixture is stirred (agitated) until all the magnesium dissolves into solution. At that point, the beaker with the mixture is covered.

Next, a second mixture is prepared with ingredients j. through p., for example, in an Erlenmeyer flask, as follows:
j. 168 mg Sodium Acid Sulfate (phase)
k. 275 mg Tartaric Acid
l. 535 mg glucono-δ-lactone
m. 10 mg Monk Fruit extract
n. 10 microliters Peach flavor
o. 15 microliters blueberry flavor
p. 56 ml Distilled Water

Then, heat is applied to the flask to heat the composition to just below boiling, for example, 205 degrees Fahrenheit, or get as close to boiling as possible, with minimal bubbling.

The first mixture is added to the heated second mixture, and stirred, for example, using a magnetic mixer. Once then thoroughly mixed, the flask containing the mixtures is cooled in an ice bath, until the contents reach room temperature or below. The mixture, however, should not drop below 32 degrees Fahrenheit.

Then, the combined mixture is measured for packaging. For example, 60 ml lots may be prepared in reliance upon a graduated cylinder to realize exactly 60 ml, which is then added to a 2 ounce container, such as PET bottle. Preferably, an induction seal is then imposed onto the cap and the cap closed the induction sealing process is implemented.

The quantities of the various ingredients comprising the inventive compositions are not limited to those disclosed in the exemplary embodiment just described, but may vary, on a per serving basis:
glycine in the amount of 0.001 to 25 grams
a choline derivative in the amount of 0.001 to 10 grams
l-tartaric acid in the amount of 0.001 to 10 grams
l-malic acid in the amount of 0.001 to 10 grams
l-tryptophan in the amount of 0.001 to 8 grams
glucono-δ-lactone in the amount of 0.001 to 10 grams
sodium bisulfate in the amount of 0.001 to 10 grams
monk fruit in the amount of 0.001 to 10 grams
potassium in the amount of 0.001 to 10 grams
magnesium in the amount of 0.001 to 5 grams
sodium in the amount of 0.001 to 10 grams
iron in the amount of 0.001 to 2 grams
chloride in the amount of 0.001 to 10 grams
sulfate in the amount of 0.001 to 20 grams
pyridoxal 5 phosphate in the amount of 0.001 to 5 grams
amino acid derivatives in the amount of 0.001 to 20 grams
one or more chelates in the amount of 0.001 to 20 grams

The inventive compositions in the form of tablets, capsules, or solutions/suspensions for oral administration, buccal or sublingual lozenges, additives for food or beverages, or other suitable forms include glycine, but also may comprise substances which are converted to glycine, or combinations of glycine with the latter. The inventive compositions further comprise one or more of: vitamins (including, but not limited, to B-vitamins), electrolytes, enzymes, food acids, amino acids, trace elements, proteins, fats, fatty acids, macronutrients, micronutrients, and/or phytochemicals, as will be recognized by persons of ordinary skill in the art.

### Example 2

A product efficacy study for the exemplary embodiment was conducted throughout April 2022 at the Hollywood Gym in Los Angeles, California. Pre-product use and post-product use surveys were conducted with qualified respondents who indicated a desire to fall asleep faster and wake-up feeling more refreshed and alert. Participants were screened verbally and/or by QR code survey, then again online by the following criteria:

Men and women aged 21 and older who were not pregnant or breastfeeding, who reported that: 1) they do not readily fall asleep in less than 15 minutes, and 2) do not wake up immediately feeling refreshed and alert. Participants did not take doctor-prescribed medication for psychiatric conditions including, but not limited, to depression, adult attention deficit disorder, or schizophrenia, and did not use any illicit drugs or non-doctor prescribed medications. Participants were further screened for and excluded based on symptoms of COVID-19 disease, food allergies, or employment in market research or the food and beverage industry.

Pre-product use and post-product use survey contents include time to fall asleep, time to return to sleep, wake-up feeling refreshed and the usage of caffeine in the mornings, in addition to likelihood of future use and product recommendations.

Participants received a $5 gift card for the pre-product survey and a $20 gift card for completing the post-product evaluation within 3 days of receiving the product for an in-home post-product use evaluation.

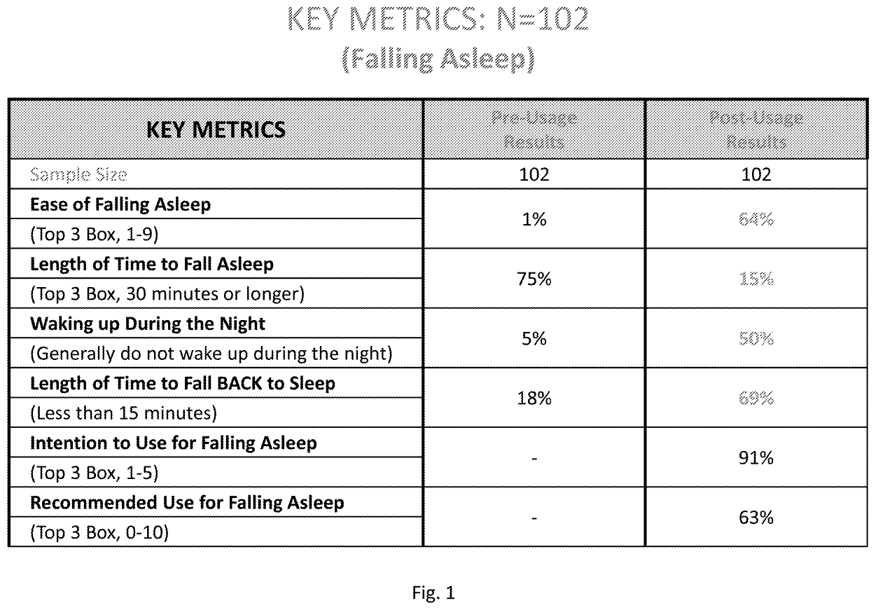

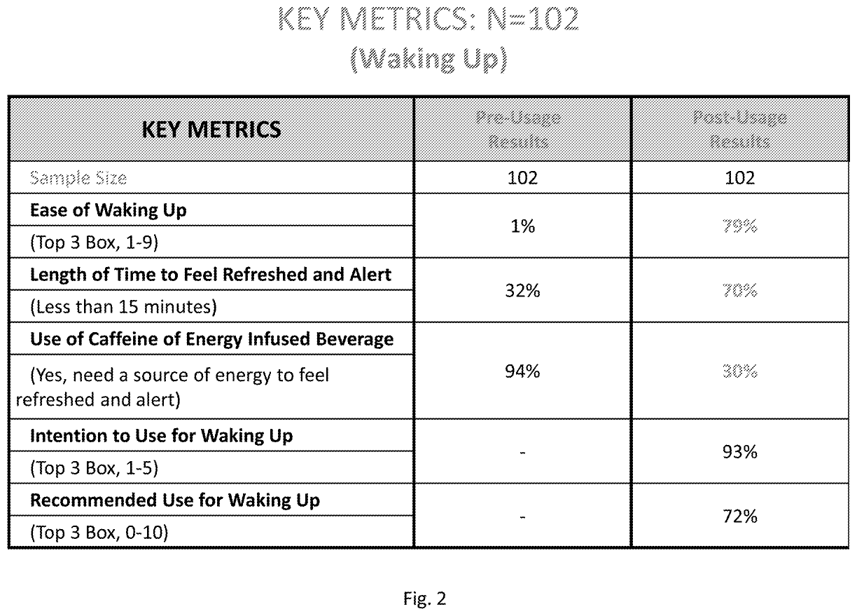

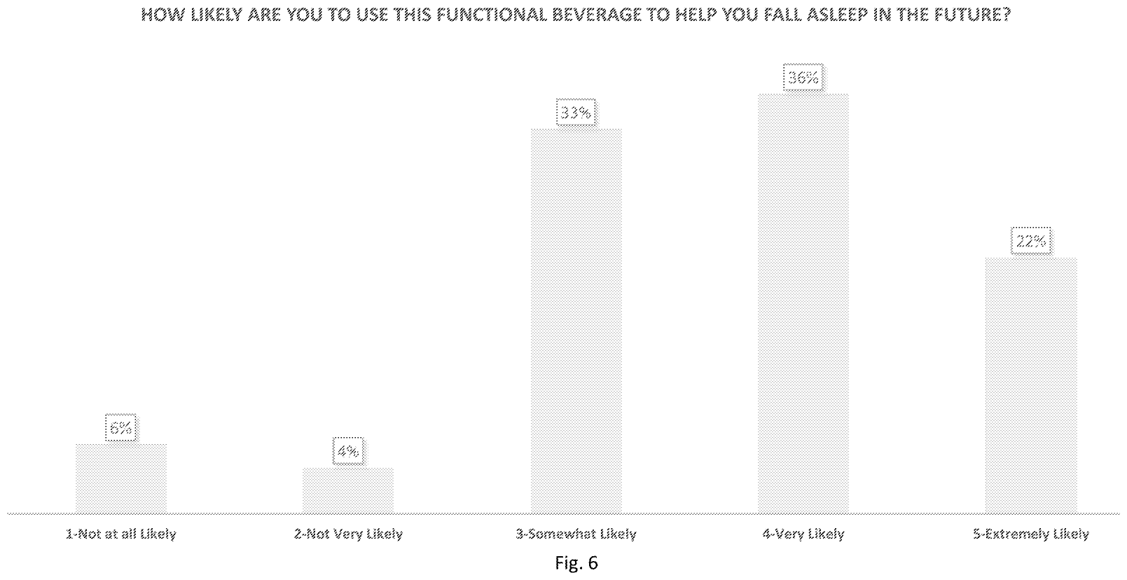

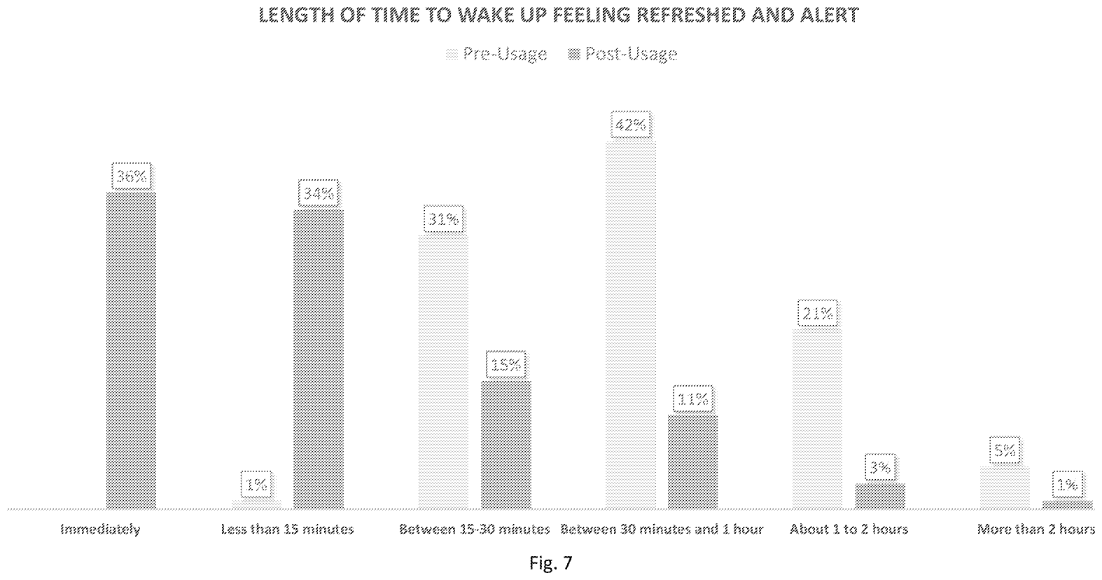

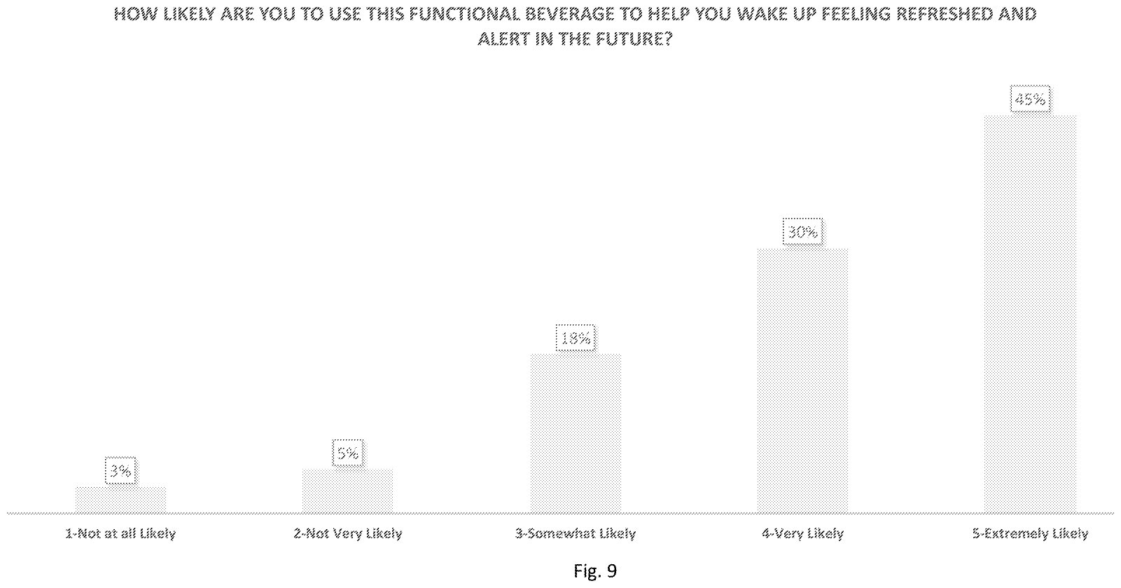

Overall, the exemplary embodiment significantly improved the ability to fall asleep AND to wake up feeling refreshed and alert. FIGS. 1, 3, 7. Further, 91% of participants were “Somewhat”, “Very”, or “Extremely Likely” to use the exemplary embodiment in the future to help fall asleep. FIG. 6. 93% were “Somewhat”, “Very”, or “Extremely Likely” to use the exemplary embodiment in the future to wake up feeling refreshed and alert. FIG. 7. 63% of participants would recommend the exemplary embodiment for falling asleep. FIG. 2. 72% of the study participants would recommend the exemplary embodiment for waking up feeling refreshed and alert. FIGS. 2, 9.

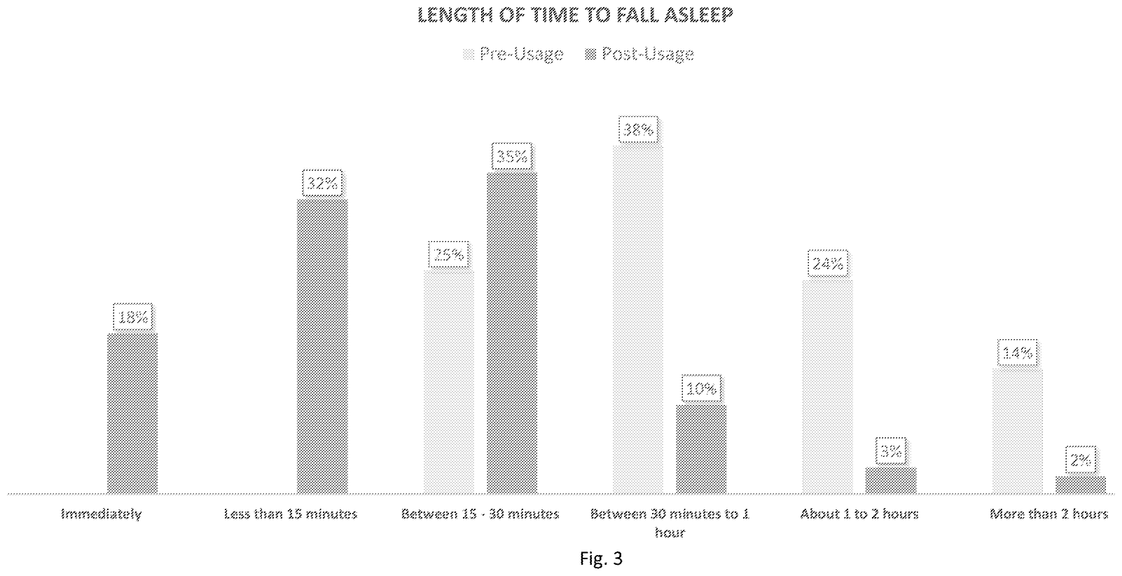

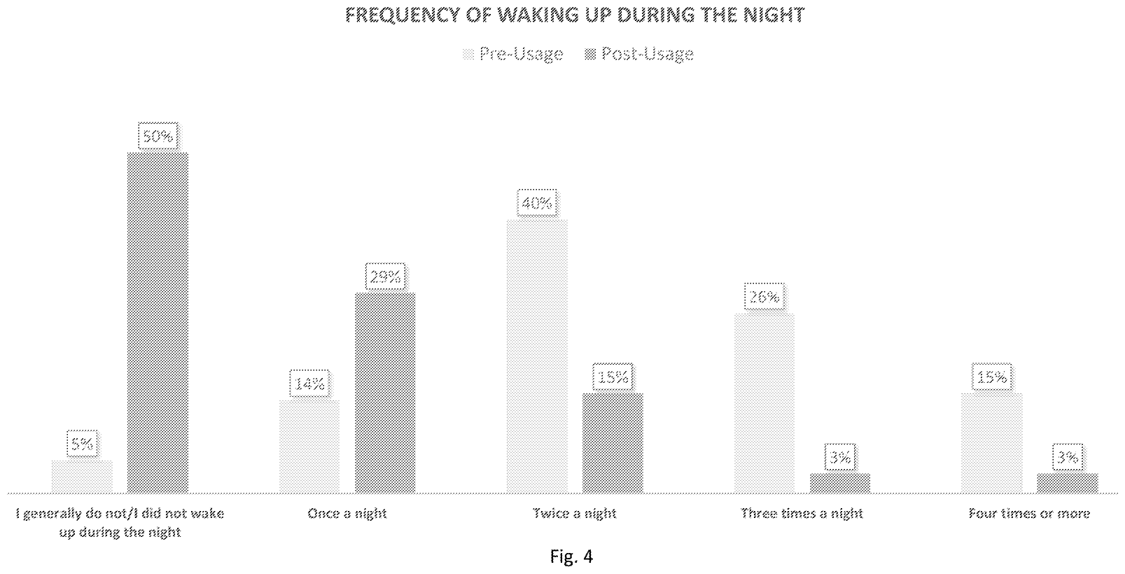

With respect to time to fall asleep, 50% of the study participants responded that the exemplary embodiment helped them fall asleep “Immediately” or within “15 minutes or less.” FIG. 3. Those participants responding that they “generally do not/did not wake up during the night” increased from 5% PRIOR to using the exemplary embodiment to 50% AFTER use. FIG. 4.

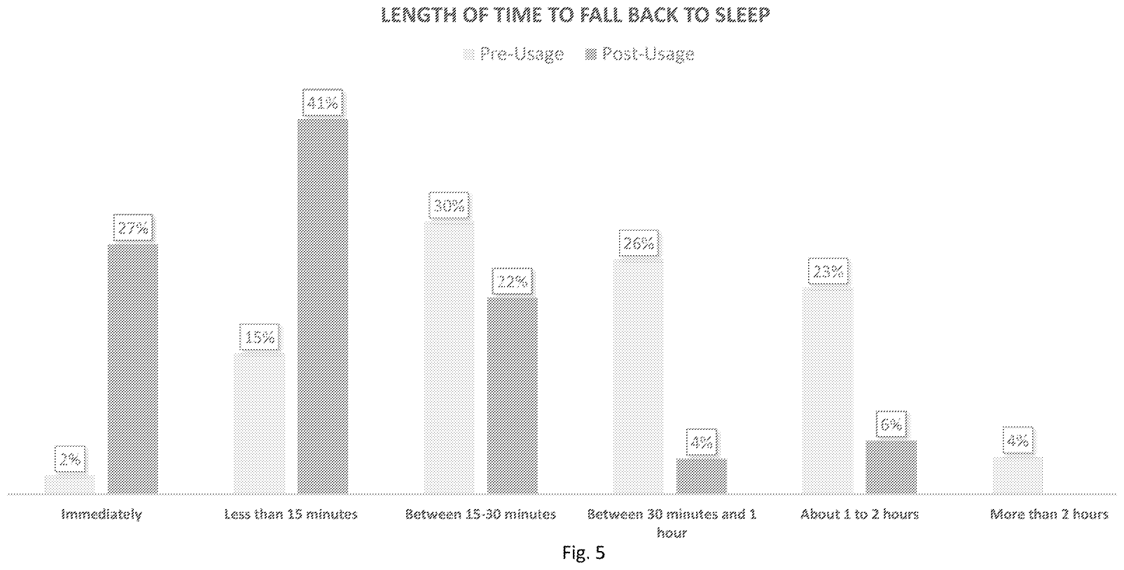

With respect to time to fall asleep again after awakening during the night, 17% of participants reported 15 minutes or less PRIOR to using the exemplary embodiment, and 68% reported 15 minutes or less AFTER use. FIG. 5.

With respect to waking up feeling refreshed and alert after use, 70% of the study participants reported that the exemplary embodiment helped them wake up feeling refreshed and alert “Immediately” or within “15 minutes or less.” FIG. 7. Further, 94% of the study participants reported needing a source of caffeine or an energy infused beverage upon waking up prior to using the exemplary embodiment, and that number decreased to 30% AFTER use.

Although the foregoing invention has been described in terms of certain specific embodiments, other embodiments of the invention will be apparent to those of ordinary skill in the art from the disclosure herein. Moreover, the described embodiments have been presented by way of example only and are not intended to limit the scope of the disclosure. Indeed, the novel compositions, processes and methods described herein may be embodied in a variety of other forms without departing from the principle of this invention and its chief advantages. The terms and expressions have been used as terms of description and not terms of limitation. There is no intention to use the terms or expressions to exclude any equivalents of features shown and described in portions thereof and this invention should be defined in accordance with the claims which follow.

What is claimed is:

1. A glycine-based nutritional supplement composition for regulating sleep and energy availability, the composition comprising, within a single serving quantity of said composition, 4 to 12 g glycine, 20 to 60 mg Himalayan rock minerals, 57 to 162 mg potassium chloride, 100 to 300 mg l-malic acid, 157 to 472 mg choline l-bitartrate, 2 to 6 mg ferrous sulfate, 7 to 22 mg l-tryptophan, 20 to 60 mg pyridoxal-5-phosphate, 100 to 300 mg magnesium chloride, 84 to 252 mg sodium acid sulfate, 137 to 412 mg tartaric acid, 268 to 803 mg glucono-δ-lactone, and 5 to 15 mg monk fruit extract.

2. The glycine-based nutritional supplement composition of claim 1, wherein the composition is incorporated into an aqueous solution for oral consumption.

3. The glycine-based nutritional supplement composition of claim 2, wherein the single serving quantity of said aqueous solution is 2 ounces.

4. The glycine-based nutritional supplement composition of claim 1, wherein the composition is formulated into a solid dosage form for oral administration, said dosage form being a tablet.

5. The glycine-based nutritional supplement composition of claim 1, wherein the composition is formulated into a solid dosage form for oral administration, said dosage form being a capsule.

6. The glycine-based nutritional supplement composition of claim 1, wherein the composition is formulated into a solid dosage form for oral administration, said dosage form being an effervescent tablet.

7. The glycine-based nutritional supplement composition of claim 1, wherein the composition is formulated into a solid dosage form for oral administration, said dosage form being a lozenge for buccal or sublingual administration.

8. The glycine-based nutritional supplement composition of claim 1, wherein the composition is formulated into a solid dosage form for oral administration, said dosage form being a powder for reconstitution in aqueous liquid.

9. The glycine-based nutritional supplement composition of claim 4 or 5, wherein the solid dosage form provides for controlled release of the composition.

10. A glycine-based nutritional supplement composition for regulating sleep and energy availability, the composition comprising one or more of glycine and substances convertible to glycine, and further comprising one or more of Himalayan rock minerals, potassium chloride, l-malic acid, choline l-bitartrate, ferrous sulfate, l-tryptophan, magnesium chloride, sodium acid sulfate, tartaric acid, glucono-δ-lactone, monk fruit extract, and B vitamins.

11. The glycine-based nutritional supplement composition of claim 10, wherein the composition is incorporated into an aqueous solution for oral consumption.

12. The glycine-based nutritional supplement composition of claim 10 wherein the composition is formulated into a solid dosage form for oral administration, said dosage form being a tablet.

13. The glycine-based nutritional supplement composition of claim 10, wherein the composition is formulated into a solid dosage form for oral administration, said dosage form being a capsule.

14. The glycine-based nutritional supplement composition of claim 10, wherein the composition is formulated into a solid dosage form for oral administration, said dosage form being an effervescent tablet.

15. The glycine-based nutritional supplement composition of claim 10, wherein the composition is formulated into a solid dosage form for oral administration, said dosage form being a lozenge for buccal or sublingual administration.

16. The glycine-based nutritional supplement composition of claim 10, wherein the composition is formulated into a solid dosage form for oral administration, said dosage form being a powder for reconstitution in aqueous liquid.

17. The glycine-based nutritional supplement composition of claim 15 or 16, wherein the solid dosage form provides for controlled release of the composition.

18. A glycine-based nutritional supplement composition for regulating sleep and energy availability, the composition comprising one or more of glycine and substances convertible to glycine.

19. The glycine-based nutritional supplement composition of claim 18 wherein the composition is formulated into a solid dosage form for oral administration.

20. The glycine-based nutritional supplement composition of claim 18 wherein the composition is formulated into a solid dosage form for oral administration, and wherein said solid dosage form provides for controlled release of the composition.

21. A method of improving sleep and providing wake-up energy to a user comprising administering to the user an effective amount of a glycine-based composition comprising, within a single serving quantity of said composition, 4 to 12 g glycine, 20 to 60 mg Himalayan rock minerals, 57 to 162 mg potassium chloride, 100 to 300 mg l-malic acid, 157 to 472 mg choline l-bitartrate, 2 to 6 mg ferrous sulfate, 7 to 22 mg l-tryptophan, 20 to 60 mg pyridoxal-5-phosphate, 100 to 300 mg magnesium chloride, 84 to 252 mg sodium acid sulfate, 137 to 412 mg tartaric acid, 268 to 803 mg glucono-δ-lactone, and 5 to 15 mg monk fruit extract; wherein the effective amount of the composition is effective to simultaneously improve sleep and provide energy to the user.

22. The method of claim 21, wherein the glycine-based composition is incorporated into an aqueous solution for oral consumption.

23. The method of claim 22, wherein the single serving quantity of said aqueous solution is two ounces.

24. The method of claim 21, wherein the glycine-based composition is formulated into a solid dosage form for oral administration, said dosage form being a tablet.

25. The method of claim 21, wherein the glycine-based composition is formulated into a solid dosage form for oral administration, said dosage form being a capsule.

26. The method of claim 21, wherein the glycine-based composition is formulated into a solid dosage form for oral administration, said dosage form being an effervescent tablet.

27. The method of claim 21, wherein the glycine-based composition is formulated into a solid dosage form for oral administration, said dosage form being a lozenge for buccal or sublingual administration.

28. The method of claim 21, wherein the glycine-based composition is formulated into a solid dosage form for oral administration, said dosage form being a powder for reconstitution in aqueous liquid.

29. The method of claim 27 or 28, wherein the solid dosage form provides for controlled release of the glycine-based composition.

30. The method of claim 21, wherein said single serving quantity of said glycine-based composition is administered prior to falling asleep at night.

31. A method of simultaneously improving sleep in and providing energy to a user comprising administering to the user an effective amount of a glycine-based composition comprising one or more of glycine and substances convertible to glycine, and further comprising one or more of Himalayan rock minerals, potassium chloride, l-malic acid, choline l-bitartrate, ferrous sulfate, l-tryptophan, magnesium chloride, sodium acid sulfate, tartaric acid, glucono-δ-lactone, monk fruit extract, and B vitamins; wherein the effective amount of the composition is effective to simultaneously improve sleep and provide energy to the user.

32. The method of claim 31, wherein the glycine-based composition is incorporated into an aqueous solution for oral consumption.

33. The method of claim 31, wherein the glycine-based composition is formulated into a solid dosage form for oral administration, said dosage form being a tablet.

34. The method of claim 31, wherein the glycine-based composition is formulated into a solid dosage form for oral administration, said dosage form being a capsule.

35. The method of claim 31, wherein the glycine-based composition is formulated into a solid dosage form for oral administration, said dosage form being an effervescent tablet.

36. The method of claim 31, wherein the glycine-based composition is formulated into a solid dosage form for oral administration, said dosage form being a lozenge for buccal or sublingual administration.

37. The method of claim 31, wherein the glycine-based composition is formulated into a solid dosage form for oral administration, said dosage form being a powder for reconstitution in aqueous liquid.

38. The method of claim 36 or 37, wherein the solid dosage form provides for controlled release of the glycine-based composition.

39. A method of simultaneously improving sleep in and providing energy to a user comprising administering to the user an effective amount of a glycine-based composition comprising one or more of glycine and substances convertible to glycine, wherein the effective amount of the composition is effective to simultaneously improve sleep and provide energy to the user.

40. The method of claim 39, wherein the glycine-based composition is formulated into a solid dosage form for oral administration.

41. The method of claim 39, wherein the glycine-based composition is formulated into a solid dosage form for oral administration, and wherein said solid dosage form provides for controlled release of the composition.

42. A n glycine-based nutritional supplement composition comprising 4 to 12 g glycine, 20 to 60 mg Himalayan rock minerals, 57 to 162 mg potassium chloride, 100 to 300 mg l-malic acid, 157 to 472 mg choline l-bitartrate, 2 to 6 mg ferrous sulfate, 7 to 22 mg l-tryptophan, 20 to 60 mg pyridoxal-5-phosphate, 100 to 300 mg magnesium chloride, 84 to 252 mg sodium acid sulfate, 137 to 412 mg tartaric acid, 268 to 803 mg glucono-o-lactone, 5 to 15 mg monk fruit extract, and 56 ml water, made by a process of:
(i) mixing said Himalayan rock minerals, potassium chloride, l-malic acid, choline l-bitartrate, ferrous sulfate, l-tryptophan, pyridoxal-5-phosphate, glycine, magnesium chloride and distilled water until the magnesium chloride is dissolved in a first mixture;
(ii) mixing said sodium acid sulfate, tartaric acid, glucono-δ-lactone, monk fruit extract, and distilled water in a second mixture;
(iii) heating said second mixture to just below boiling;
(iv) stirring the first mixture into the second mixture; and
(v) cooling the resulting mixture without causing it to freeze.

43. A glycine-based nutritional supplement composition comprising: a first group of ingredients comprising one or more of glycine and substances convertible to glycine, and further comprising one or more of Himalayan rock minerals, potassium chloride, l-malic acid, choline l-bitartrate, ferrous sulfate, l-tryptophan, and magnesium chloride; a second group of ingredients comprising one or more of sodium acid sulfate, tartaric acid, glucono-δ-lactone, monk fruit extract, and B vitamins; made by a process of:
(i) mixing said first group of ingredients until all of the magnesium chloride is dissolved in a first mixture;
(ii) separately making a second mixture of said second group of ingredients;
(iii) heating said second mixture to just below boiling;
(iv) stirring the first mixture into the second mixture; and
(v) cooling the resulting mixture without causing it to freeze.

44. A method of making a glycine-based nutritional supplement composition comprising:
(i) mixing 4 To 12 g glycine, 20 to 60 mg Himalayan rock minerals, 57 to 162 mg potassium chloride, 100 to 300 mg l-malic acid, 157 to 472 mg choline l-bitartrate, 2 to 6 mg ferrous sulfate, 7 to 22 mg l-tryptophan, 20 to 60 mg pyridoxal-5-phosphate, 100 to 300 mg magnesium chloride and distilled water until all of the magnesium chloride is dissolved in a first mixture;
(ii) mixing 84 to 252 mg sodium acid sulfate, 137 to 412 mg tartaric acid, 268 to 803 mg glucono-δ-lactone, 5 to 15 mg monk fruit extract, and 56 ml water in a second mixture;
(iii) heating said second mixture to just below boiling;
(iv) stirring the first mixture into the second mixture; and
(v) cooling the resulting mixture without causing it to freeze.

45. A method of making a glycine-based nutritional supplement composition comprising:
(i) mixing a first group of ingredients comprising one or more of glycine and substances convertible to glycine, and further comprising one or more of Himalayan rock minerals, potassium chloride, l-malic acid, choline l-bitartrate, ferrous sulfate, l-tryptophan, and magnesium chloride until all of the magnesium chloride is dissolved in a first mixture;
(ii) mixing a second group of ingredients comprising one or more of sodium acid sulfate, tartaric acid, glucono-δ-lactone, monk fruit extract, and B vitamins in a second mixture;
(iii) heating said second mixture to just below boiling;
(iv) stirring the first mixture into the second mixture; and
(v) cooling the resulting mixture without causing it to freeze.
